(19) United States
(12) Patent Application Publication
(10) Pub. No.: US 2005/0155521 A1
(43) Pub. Date: Jul. 21, 2005

(54) Alkoxylated polyalkyleneimines having anionic groups and their use

(76) Inventors: Udo Herrmann, Dormagen (DE); Dirk Pfuetzenreuter, Burscheid (DE); Helmut-Martin Meier, Ratingen (DE); Josef Witt, Leverkusen (DE); Hans-Jurgen Hartrumpf, Leverkusen (DE); Daniela Gesekus, Julich (DE); Gudrun-Margot Goldau, Koln (DE)

Correspondence Address: LANXESS CORPORATION, 111 RIDC PARK WEST DRIVE, PITTSBURGH, PA, 15275-1112, US

(21) Appl. No.: 10/997,011

(22) Filed: Nov. 24, 2004

(30) Foreign Application Priority Data
Nov. 28, 2003 (DE) 10356341.5

(51) Int. Cl. C09D 11/00

(52) U.S. Cl. 106/499; 528/310

(57) ABSTRACT

Polyalkylenepolyimines having alkoxy units and anionic groups, especially those from the group consisting of —COO^{σ}, —SO₃⁹⁴ , —OSO₃^{σ}, —PO₃²⁻ and —P(OR)O₂^{σ}, where R represents hydrogen or optionally substituted alky, cycloalkyl or aryl.

The present invention concerns novel polyalkyleneimines, processes for their preparation, their use as dispersants for pigments and also a pigment preparation comprising these polyalkyleneimines and its use in ink jet printing.

Aqueous printing inks for ink jet printing are well known not only on the basis of water-soluble organic dyes but also on the basis of organic colour pigments. Pigments generally provide the prints with a significantly higher light and ozone stability than dyes. The most important pigment for this application is carbon black given that carbon black ink jet prints are more document-fast, i.e. more light-stable and less prone to run when exposed to moisture or water, than black dyes.

A customary way of optimizing pigment-based inks to the printing medium and to inhibit print head encrustation is to add organic water-miscible solvents.

An undesirable side effect of the addition of organic water-miscible solvents is the competing adsorption of some solvents on pigment particles, which appreciably reduces the stability of these pigment dispersions. The stability of a solvent-containing pigment dispersion can be determined by measuring the flocculation temperature.

Functionalized pigments, for example those of U.S. Pat. No. 5,554,739 and U.S. Pat. No. 5,922,118, avoid competing adsorption, but have the disadvantage of an increased tendency to migrate and of the associated lower waterfastness.

The present invention, then, has for its object to provide a pigment dispersant whose corresponding pigment preparations possess a high solvent stability and especially a low agglomeration tendency coupled with a good start-of-print performance.

Surprisingly, the stated object is achieved by polyalkylenepolyimines having alkoxy units and anionic groups, especially those from the group consisting of —COO^{σ}, —SO₃^{σ}, —OSO₃^{σ}, —PO₃²⁻ and —P(OR)O₂^{σ}, where R represents hydrogen or optionally substituted alkyl, cycloalkyl or aryl.

Preferred cations to be mentioned are alkali metals, especially sodium, lithium and potassium, alkaline earth metals such as calcium and magnesium and also ammonium such as NH₄^{⊕}, N^{⊕}HR¹R²R³, where R¹ to R³ independently represent optionally substituted alkyl, especially optionally substituted C₁-C₄-alkyl, especially C₁-C₄-alkanols such as CH₂CH₃ OH.

Particular preference is given to cations of the formula N^{⊕}HR¹R²R³ comprising protonated ethanolamine, diethanolamine, triethanolamine, N,N′-dimethylaminoethanolamine, aminopropylmethanol or methyldiethanolamine.

Particularly good dispersants are obtained as soon as amide, urethane and/or urea groups are additionally present in the dispersant.

The polyalkylenepolyimines of the present invention preferably have an average molecular weight from 500 to 30 000 g/mol, especially 800 to 22 000 and preferably 1000 to 13 000 g/mol.

The polyalkylenepolyimine of the present invention likewise preferably possesses ethylene oxide units and propylene oxide and/or butylene oxide units, especially as a block unit.

The polyalkyleneimines of the present invention may additionally contain urea and/or urethane groups of the kind formed in the course of the reaction of alkoxylated polyalkyleneimines with monofunctional isocyanates such as aliphatic or aromatic isocyanates.

The polyalkylenepolyimine of the present invention more preferably contains anionic groups formed by reaction of alkoxylated polyalkylenepolyimines with di- or polycarboxylic acids, especially aliphatic, cycloaliphatic or aromatic ones or derivatives thereof such as in for example esters, anhydrides or acyl chlorides, sulphonating or sulphating agents such as for example sulphamic acid or chlorosulphonic acid or phosphating agents such as for example POCl₃.

In a preferred embodiment, the polyalkylenepolyimine of the present invention is obtainable by a starting polyethyleneimine which is devoid of alkoxy groups being alkoxylated, preferably initially propoxylated or butoxylated and subsequently ethoxylated (as described for example in DE-A 10 026 466), if appropriate reacted with monofunctional isocyanates and reacted with di- or polycarboxylic acids or derivatives thereof, sulphonating or phosphating agents.

Particular preference is given to those polyethyleneimines of the present invention which comprise 1 to 10 mol, especially 1 to 6 mol and particularly 2 to 5 mol of propylene oxide or butylene oxide units per mole of NH function.

The ethylene oxide content of the polyethyleneimines is preferably in the range from 10 to 40 mol, more preferably in the range from 15 to 35 mol and most preferably in the range from 20 to 30 mol of ethylene oxide units per mole of NH function.

Particularly useful polyethyleneimines according to the present invention contain at least 12, especially 20 to 45 and particularly 25 to 40 mol of alkylene oxide units per mole of NH function.

The average molecular weight of the pre-alkoxylation starting polyethyleneimine is generally in the range from 400 to 35 000 g/mol, preferably in the range from 800 to 20 000 g/mol, more preferably in the range from 800 to 12 000 g/mol and most preferably about 2500 to 3500 g/mol.

Preference is given to those polyalkylenepolyimines of the present invention which are branched, i.e. which have preferably been prepared on the basis of a starting polyalkylenepolyimine which is branched, i.e. contains tertiary amino groups.

Polyalkylenepolyimines of the present invention which are particularly preferred are polyethylenepolyimines.

It is particularly preferable for the alkoxylated polyalkylenepolyimines, especially polyethylenepolyimines, of the present invention to contain —COO^{σ}, —SO₃^{σ} or —OSO₃^{σ} groups.

The as-alkoxylated polyethyleneimines are known for example from WO-A-99/67352 and can be prepared as described therein.

These alkoxylated polyethyleneimines are preferably reacted with dicarboxylic acids, dicarboxylic anhydrides, dicarbonyl chlorides or dicarboxylic esters such as for example succinic anhydride, phthalic anhydride, hexahydrophthalic anhydride, sulphamic acid, chlorosulphonic acid, phosphorus oxychloride.

In a further preferred embodiment, the polyalkylenepolyimines of the present invention contain acid amide units, especially those of the formula R—NR′—CO—, R—NR′—SO₂— and/or R—NR′—PO₃—, where R and R′ represent hydrogen or an alkyl, cycloalkyl or aryl radical.

The alkoxylated polyalkylenepolyimine of the present invention preferably contains tertiary —NR′— groups, especially —NR′—CO— or —NR′—SO₂ groups.

The invention further provides a process for preparing the polyalkylenepolyimines of the invention, which is characterized in that alkoxylated polyalkylenepolyimines are if appropriate reacted with monofunctional isocyanates, especially with aliphatic and/or aromatic ones, such as phenyl isocyanate or stearyl isocyanate for example, and subsequently with an agent for introducing anionic groups, especially with di- and/or polycarboxylic acid or derivatives thereof, sulphonating, sulphating or phosphating agents, preferably with dicarboxylic acids, dicarboxylic anhydrides, dicarbonyl chlorides or dicarboxylic esters such as for example succinic anhydride, phthalic anhydride, hexahydrophtalic anhydride, sulphamic acid, chlorosulphonic acid or phosphorus oxychloride.

Preferred alkoxylated polyalkylenepolyimines include those mentioned in DE-A-100 26 466.

Anionic groups of strongly acidic groups are introduced for example by reaction of the alkoxylated polyalkylenepolyimines with chlorosulphonic acid, sulphamic acid, phosphoric esters or phosphoryl halides.

Anionic groups of weakly acidic groups are introduced for example by reaction of the alkoxylated polyalkylenepolyimines with di- or polycarboxylic acids or derivatives thereof such as, for example esters, anhydrides or acyl chlorides.

When monofunctional isocyanates are used, alkoxylated polyalkylenepolyimine and the corresponding isocyanates are preferably used in a molar ratio from 1:0.05 to 1:0.9 and especially 1:0.1 to 1:0.5.

The reaction with the isocyanate is preferably carried out at a temperature from 20 to 140° C., preferably at 50 to 90° C. Preference is given to a reaction time of 1-120 minutes, preferably of 10-60 minutes.

The reaction with the isocyanates preferably takes place without solvent.

Alkoxylated polyalkylenepolyimine and the appropriate agent providing anionic groups are preferably used in molar ratios from 1:0.1 to 1:1 and especially 1:0.25 to 1:1.

The reaction temperature is preferably in the range from 90 to 140° C. and especially in the range from 95 to 120° C.

Dispersion properties such as for example filterability and printability are particularly good when the reaction with the agents providing anionic groups, especially that with di- and polycarboxylic acid or derivatives thereof, takes place at a temperature of not less than 110° C. and especially at 110 to 140° C.

The reaction mixture obtained is preferably diluted with completely ion-free water such that a solution which is flowable at room temperature is produced. The amount of water added to this end is especially 10 to 40%, based on the volume of the reaction mixture. This solution is neutralized with suitable bases to a pH of >7.5. It is preferable to neutralize with inorganic bases such as KOH, NaOH, ammonia and organic bases such as ethanolamine, diethanolamine, triethanolamine, N,N′-dimethylaminoethanol, aminopropylmethanol, methyldiethanolamine. It is preferable for salt-containing reaction mixtures, formed by reactions of acid amides and acyl chlorides with the alkoxylated polyalkyleneimines, to be substantially desalted by means of membrane separation processes to a salt content of preferably less than 1%. The process parameters for the desalting are described for example in EP-A 816406.

Ester and amide groups are detectable in the infrared spectrum of the non-neutralized alkoxylated polyalkylenepolyimine.

The invention further provides the anion-functionalized alkoxylated polyalkylenepolyimines obtainable by the process of the present invention.

The invention further provides pigment preparations comprising

A) at least one pigment, and

B) at least one polyethylenepolyimine according to the present invention.

The pigment preparation may be solid, especially a pulverulent or granular solid, but preference is given to aqueous pigment preparations, especially those comprising

A) at least one pigment,

B) at least one polyalkylenepolyimine according to the present invention, and

C) aqueous medium.

Useful pigments A) include not only inorganic but also organic particulate pigments, especially those where more than 95% and preferably more than 99% of the pigment particles A) are not more than 1 μm, preferably not more than 0.5 μm and especially equal to 0.2 μm in size.

“Organic pigments” as used herein also comprehends dyes which are virtually insoluble in the medium and especially vat dyes. It will be appreciated that the pigment preparations according to the invention can also include mixtures of various organic or various inorganic pigments or of organic and inorganic pigments.

Examples of suitable pigments (A) include:

Organic pigments:
Azo pigments:
Monoazo pigment:

C.I. Pigment Brown 25;

C.I. Pigment Orange 5, 13. 36 and 67;

C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251;

C.I. Pigment Yellow 1, 3, 73, 74, 65, 97, 151 and 183;
Disazo pigments:

C.I. Pigment Orange 16, 34 and 44;

C.I. Pigment Red 144, 166, 214 and 242;

C.I. Pigment Yellow 12, 13, 14, 16, 17, 81, 83, 106, 113, 126, 127, 155, 174, 176 and 188,
Anthanthrone pigments:

C.I. Pigment Red 168

(C.I. Vat Orange 3);
Anthraquinone pigments:

C.I. Pigment Yellow 147 and 177;

C.I. Pigment Violet 31;
Anthrapyrimidine pigments:

C.I. Pigment Yellow 108

(C.I. Vat Yellow 20),
Quinacridone pigments:

C.I. Pigment Red 122, 202 and 206;

C.I. Pigment Violet 19;
Quinophthalone pigments:

C.I. Pigment Yellow 138;
Dioxazine pigments:

C.I. Pigment Violet 23 and 37,
Flavanthrone pigments:

C.I. Pigment Yellow 24;

(C.I. Vat Yellow 1);
Indanthrone pigments:

C.I. Pigment Blue 60;

(C.I. Vat Blue 4)

and 64 (C.I. Vat Blue 6);
Isoindoline pigments:

C.I. Pigment Orange 69;

C.I. Pigment Red 260;

C.I. Pigment Yellow 139 and 185;
Isoindolinone pigments:

C.I. Pigment Orange 61;

C.I. Pigment Red 257 and 260;

C.I. Pigment Yellow 109, 110, 173 and 185;
Isoviolanthrone pigments:

C.I. Pigment Violet 31;

(C.I. Vat Violet 1);
Metal complex pigments:

C.I. Pigment Yellow 117, 150 and 153;

C.I. Pigment Green 8;
Perinone pigments:

C.I. Pigment Orange 43;

(C.I. Vat Orange 7);

C.I. Pigment Red 194;

(C.I. Vat 15);
Perylene pigments:

C.I. Pigment Black 31 and 32;

C.I. Pigment Red 123, 149, 178, 179, (C.I. Vat Red 23), 190 and 240;

C.I. Pigment Violet 29;
Phthalocyanine pigments:

C.I. Pigment Blue 15, 15:1, 15:2, 15:3, 15:4, 15:6 and 16;

C.I. Pigment Green 7 and 36;
Pyranthrone pigments:

C.I. Pigment Orange 51;

C.I. Pigment Red 216;

(C.I. Vat Orange 4);
Thioindigo pigments:

C.I. Pigment Red 88 and 181;

(C.I. Vat Red 1);

C.I. Pigment Violet 38;

(C.I. Vat Violet 3);
Triarylcarbonium pigments:

C.I. Pigment Blue 1, 61 and 62;

C.I. Pigment Green 1;

C.I. Pigment Red 81, 81:1 and 169;
C.I. Pigment Black 1 (aniline black);
C.I. Pigment Yellow 101 (aldazine yellow);
C.I. Pigment Brown 22.

Vat dyes (apart from those already mentioned above):
C.I. Vat Yellow 2, 3, 4, 5, 9, 10, 12, 22, 26, 33, 37, 46, 48, 49 and 50;
C.I. Vat Orange 1, 2, 5, 9, 11, 13, 15, 19, 26, 29, 30 and 31;
C.I. Vat Red 2, 10, 12, 13, 14, 16, 19, 21, 31, 32, 37, 41, 51, 52 and 61;
C.I. Vat Violet 2, 9, 13, 14, 15, 17 and 21;
C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74;
C.I. Vat Green 1, 2, 3,5, 7, 8, 9, 13, 14, 17, 26, 29, 30, 31, 32, 33, 40, 42, 43, 44 and 49;
.I. Vat Green 1, 2, 3, 5, 7, 8, 9, 13, 14, 17, 26, 29, 30, 31, 32, 33, 40, 42, 43, 44 and 49;
C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84,
C.I. Vat Black 1, 2, 7, 8, 9, 13, 14, 16, 19, 20, 22, 25, 27, 28, 29, 30, 31, 32, 34, 36, 56, 57, 58, 63, 64and65;

Pyrrolopyrrole pigments
C.I. Pigment Red 255, 254, and 264

Inorganic pigments:
White pigments:

Titanium dioxide (C.I. Pigment White 6), zinc white, pigment grade zinc oxide; zinc sulphide, lithopone; lead white;
Black pigments:

Iron oxide black (C.I. Pigment Black 11), iron manganese black, spinel black (C.I. Pigment Black 27); carbon black

(C.I. Pigment Black 7);
Chromatic pigments:

Chromium oxide, Chromium oxide hydrate green; chrome green (C.I. Pigment Green 48); cobalt green (C.I. Pigment Green 50); ultramarine green;

Cobalt blue (C.I. Pigment Blue 28 and 36); ultramarine blue; iron blue (C.I. Pigment Blue 27); manganese blue; ultramarine violet; cobalt and manganese violet;

Iron oxide red (C.I. Pigment Red 101); cadmium sulphoselenide (C.I. Pigment Red 108); molybdate red (C.I. Pigment Red 104); ultramarine red;

Iron oxide brown, mixed brown, spinel and corundum phases (C.I. Pigment Brown 24, 29 and 31), chrome orange; iron oxide yellow (C.I. Pigment Yellow 42); nickel titanium yellow (C.I. Pigment Yellow 53; C.I. Pigment Yellow 157 and 164); chromium titanium yellow; cadmium sulphide and cadmium zinc sulphide (C.I. Pigment Yellow 37 and 35); chrome yellow (C.I. Pigment Yellow 34), zinc yellow, alkaline earth metal chromates; Naples yellow; bismuth vanadate (C.I. Pigment Yellow 184);
Interference pigments:

Metal effect pigments based on coated metal platelets; pearl lustre pigments based on metal-oxide-coated mica platelets; liquid crystal pigments.

Preferred pigments in this context are monoazo pigments (especially laked BONS pigments, Naphtol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks (especially gas or furnace blacks).

Examples of particularly preferred pigments are specifically: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7, Pigment Yellow 139, Pigment Yellow 150, Pigment Yellow 128, Pigment Green 36, Pigment Red 177, Pigment Red 254.

Particularly preferred pigments are those of the type of carbon blacks which have a pH>6, especially <5.0, in a 5% aqueous slurry, such as Spezialschwarz® 4, Spezialschwarz® from Degussa, 4a, Spezialschwarz® 5, Spezialschwarz® 6, Spezialschwarz® 100, Spezialschwarz® 250, Spezialschwarz® from Degussa, 350, Spezialschwarz 550 and also pigment grade carbon blacks of the types FW 200, FW 2, FW 2V, FW 285, FW 1, FW 18, S 160, S 170 from Degussa, Printex grades, from Degussa, Pigment Yellow 150, Pigment Yellow 74, Pigment Blue 15:3, Pigment blue 15:2, Pigment blue 15:1 and Pigment Red 122.

The solid pigment preparation is preferably more than 90% by weight and especially more than 95% by weight in the two components A) and B).

The pigment preparations of the present invention preferably comprise 5 to 300% by weight and especially 20 to 100% by weight of the present invention's polyalkyleneimine of component B), based on the weight of the pigment of component A).

For the aqueous preparation, the fraction of the pigment component A) is preferably in the range from 0.5% to 50% by weight, more preferably in the range from 1% to 40% by weight and even more preferably in the range from 2% to 30% by weight, based on the aqueous preparation.

The aqueous medium of component C) can be either water (C1) alone or a mixture of water with organic solvents (C2), in which case these preferably have a water solubility of more than 5 g/l at 20° C.

Useful organic solvents (C2) for component C) include for example: aliphatic C₁-C₄-alcohols, linear or branched, pentanediol, aliphatic ketones such as acetone, methyl ethyl ketone, diacetone alcohol, polyols such as ethylene glycol, diethylene glycol, triethylene glycol, polyglycols having a molar mass of 200-2000 g/mol, propylene glycol, dipropylene glycol, tripropylene glycol, trimethylolpropane, glycerol, thiodiglycol, 2-pyrrolidone, N-methylpyrrolidone, N-ethylpyrrolidone, 1,3-dimethylimidazolidinone, dimethylacetamide, dimethylformamide and also alkylpolyglycol ethers, preferably C₁-C₆-alkylpolyglycol ethers, especially those having up to 8 ether units, more preferably butyldiglycol and/or butyldiglycol. Mixtures of solvents mentioned also come into consideration.

The amount of the organic solvent is preferably 0-50% by weight, especially 0-35% by weight and more preferably in the range from 5% to 15% by weight, based on the preparation. The pigment preparation may further contain agents to adjust the viscosity, for example polyvinyl alcohol, polyvinylpyrrolidone, methylcellulose, xanthans, provided they have no adverse effect on the stability, the printing performance and the drying performance on paper.

The main constituent of the preferred aqueous pigment preparations is preferably water (C1). Its content is customarily in the range from 50% to 95% by weight and preferably in the range from 60% to 80% by weight.

Particularly preferred pigment preparations comprise

A) at least one pigment, especially carbon black,

B) at least one polyalkylenepolyimine according to the present invention,

C1) water, and

C2) at least one organic solvent from the group of the alkylpolyglycol ethers, preferably C₁-C₆-alkylpolyglycol ethers, especially those having up to 8 ether units, more preferably butyltriglycol and/or butyldiglycol and/or butylglycol.

Preferably, more than 10% by weight of organic solvent corresponds to component C2), especially 10% to 50% by weight, based on aqueous medium C).

The pigment preparation may further contain pH regulators such as NaOH, KOH, aminoethanol, aminomethylpropanol, triethanolamine, N,N-dimethylaminoethanol, diethanolamine or methyldiethanolamine.

As preservatives there are to be understood for example isothiazolines for example 1,2-benzisothiazol-3 -(2H)-one, chloro-2-methyl-4-isothiazolin-3-one or 2-methyl-4-isothiazolin-3-one, sodium pentachlorophenoxide, 1,3,5-triethylolhexahydro-s-triazine or mixtures thereof, the amount of preservatives used generally being 0-1% by weight, preferably 0.05-0.5% by weight and especially 0.0001-0.2% by weight based on the preparation.

The invention further provides a process for preparing the pigment preparation of the present invention, which process is characterized in that said components A) and B) are homogenized in the presence of water (C1) and if appropriate other components, such as for example organic solvents (C2), if appropriate subsequently freed of coarse particles, preferably by means of a 1-10 μm membrane, a glass filter or paper cloth, and if appropriate the pigment preparation is dried.

The homogenizing is preferably effected by beating the individual components in a dissolver and then grinding in a high energy bead mill using zirconium oxide beads for example.

The preparation is then generally filtered, for example through 1-10 μm membrane or glass fibre filters.

The pigment preparations of the present invention exhibit excellent storage stability and provide prints of excellent lightfastness not only on thermal bubble jet printers (from HP, Encad for example) but also on piezo printers (for example those from Epson, Canon or Mutoh).

In addition, they have the following advantages: no clogging of print head and also high water fastness and migration fastness.

The aqueous pigment preparations according to the invention are very useful for printing sheetlike or three-dimensionally configured substrates by the ink jet process, which is characterized in that the ink jet inks are printed onto the substrate and the print obtained is then fixed if desired.

The ink jet process is usually carried out with aqueous inks, which are sprayed as small droplets directly onto the substrate. There is a continuous form of the process, in which the ink is pressed at uniform rate through a nozzle and the jet is directed onto the substrate by an electric field depending on the pattern to be printed, and there is an interrupted ink jet or drop-on-demand process, in which the ink is expelled only where a coloured dot is to appear, the latter form of the process employing either a piezoelectric crystal or a heated hollow needle (bubble or thermal jet process) to exert pressure on the ink system and so eject an ink droplet. These techniques are described in Text Chem. Color, Band 19 (8), pages 23 to 29, 1987, and volume 21 (6), pages 27 to 32.

The ink jet inks according to the invention are particularly useful for the bubble jet process and for the process employing a piezoelectric crystal.

When the print is to be fixed, it is possible to proceed in a known manner and for example as described in WO-A-99/01516 and, for example, for a binder, if desired in the form of a dispersion or emulsion, to be applied atop the printed substrate and cured or for a film to be laminated onto the printed substrate.

Further details concerning these binders are to be found in WO-A-99/01516.

The aqueous bead preparations according to the invention can be printed on all kinds of substrate materials. Examples of substrate materials include
coated or uncoated cellulosics such as paper, paperboard, cardboard, wood and woodbase,
coated or uncoated metallic materials such as foils, sheets or workpieces composed of aluminium, iron, copper, silver, gold, zinc or alloys thereof,
coated or uncoated silicatic materials such as glass, porcelain and ceramics,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding block and nonblock copolymers, biodegradable polymers and natural polymers such as gelatin,
textile materials such as fibres, yarns, threads, knits, wovens, nonwovens and made-up product composed of polyesters, modified polyester, polyester blend fabric, cellulosics such as cotton, cotton blend fabric, jute, flax, hemp and ramie, viscose, wool, silk, polyamide, polyamide blend fabric, polyacrylonitrile, triacetate, acetate, polycarbonate, polypropylene, polyvinyl chloride, polyester microfibres and glass fibre fabric, leather, in the form of smooth leather, nappa leather or suede leather,
comestibles and cosmetics.

The aqueous recording fluids (inks) are preferably obtained by adjusting the pigment preparations obtained by the process according to the invention to the desired colour strength by addition of water and/or organic solvents.

Measurement of the Flocculation Temperature

The pigment preparations of the present invention are notable for excellent flocculation stability. Their flocculation temperature is preferably >65° C. and especially >80° C. The flocculation temperature is that temperature at which the dilatational viscosity has increased by a factor of 10 compared with the dilatational viscosity at 20° C.

The flocculation temperature was measured using a dilatational viscometer, an RS 150 oscillation rheometer from Haaka. The dilatational viscosity was measured in the temperature range of 20-95° C. The measuring system was a plate-plate system having a spacing of 0.501 mm, i.e. the dispersion to be measured was situated between 2 circular parallel plates 0.501 mm apart. The force pickup sensor was of the PP60 93037 type.

Summary of the Principle of the Measurement:

The dispersant molecules have been physically adsorbed on the pigment particle. There is an equilibrium between the dispersant molecules adsorbed on the pigment and the dispersant molecules in solution. When a dispersion is optimal, this equilibrium and hence the stability of the dispersion remains almost constant over a large temperature range.

If, however, there is competition for adsorption on the pigment due to solvent molecules, there will be fewer dispersant molecules on the pigment particle and more dispersant particles in solution. This causes the dilatational viscosity to increase.

The measurement of the flocculation temperature via the change in the dilatational viscosity is a very sensitive indicator of the stability of dispersions under the influence of solvents.

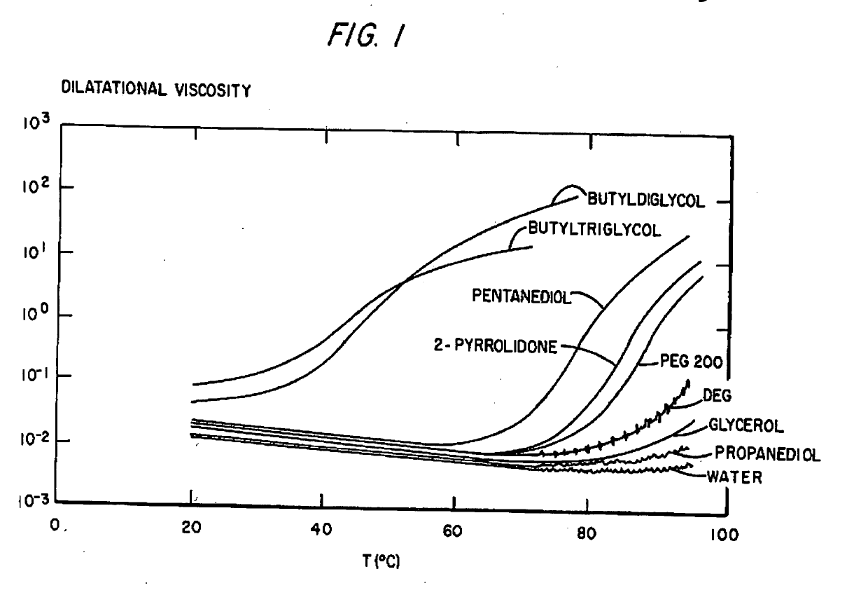

FIG. 1 illustrates the flocculation behaviour of a commercially available carbon black dispersion to which different solvents have been added. The carbon black is of the Degussa Spezialschwarz 4 type, and the dispersant is a mixture of salt-free naphthalenesulphonic acid-formaldehyde condensate and of an ethoxylated and anion-functionalized tristyryl ethoxylate. Glycerol, diethylene glycol (DEG) and propanediol have only little effect on the system. Pentanediol, polyethylene glycol 200 (PEG 200) and 2-pyrrolidone lower the flocculation temperature by more than 10°. The amphiphilic solvents butyldiglycol and butyltriglycol start to destabilize the pigment dispersion at a temperature as low as 20°, while at 50° the dilatational viscosity is 50 times that of the aqueous dispersion.

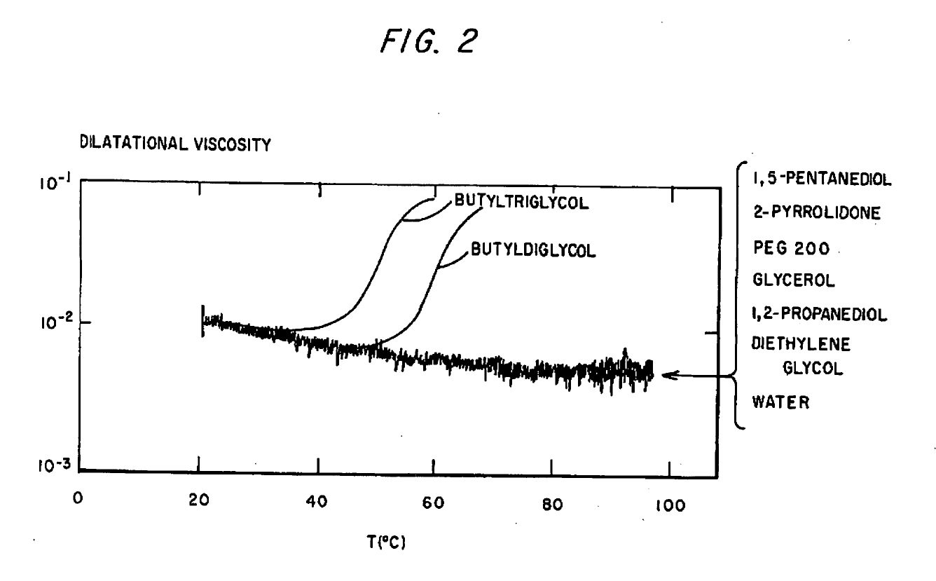

FIG. 2 illustrates the flocculation behaviour of a carbon black dispersion comprising a dispersant mixture of ethoxylated polyethyleneimine (molar mass about 2400 g/mol) (dispersant B2 from DE-A 10 026 466) and a naphthalenesulphonic acid-formaldehyde condensate as dispersant. The carbon black is a Degussa Spezialschwarz 4 type.

This pigment dispersion is destabilized by butyldiglycol and butyltriglycol.

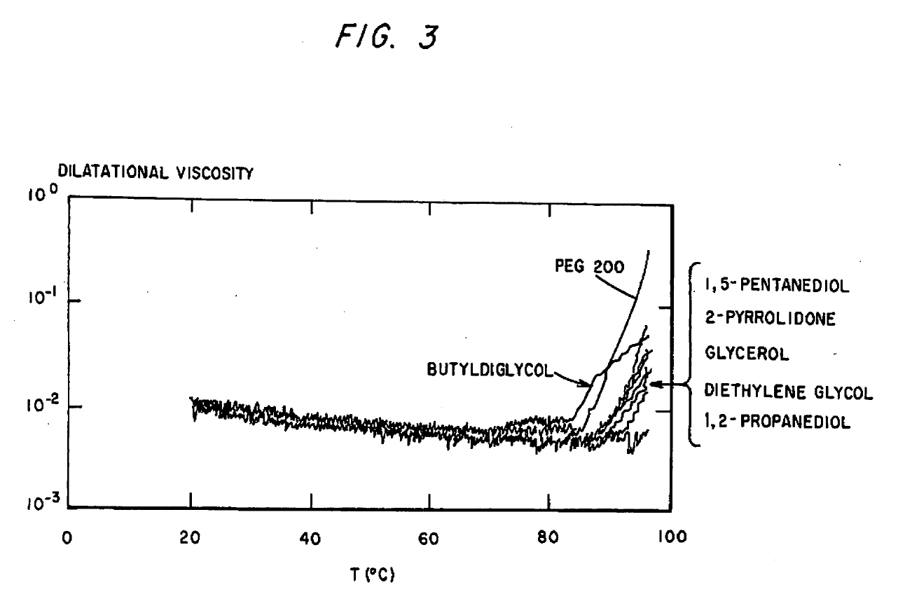

FIG. 3 illustrates the flocculation behaviour of a carbon black dispersion comprising a dispersant prepared by sulphation of an ethoxylated polyethyleneimine and subsequent desalting as per Example 1.

The carbon black is a Degussa Spezialschwarz type 4. Up to 80° C. this dispersion is stable to all solvents used.

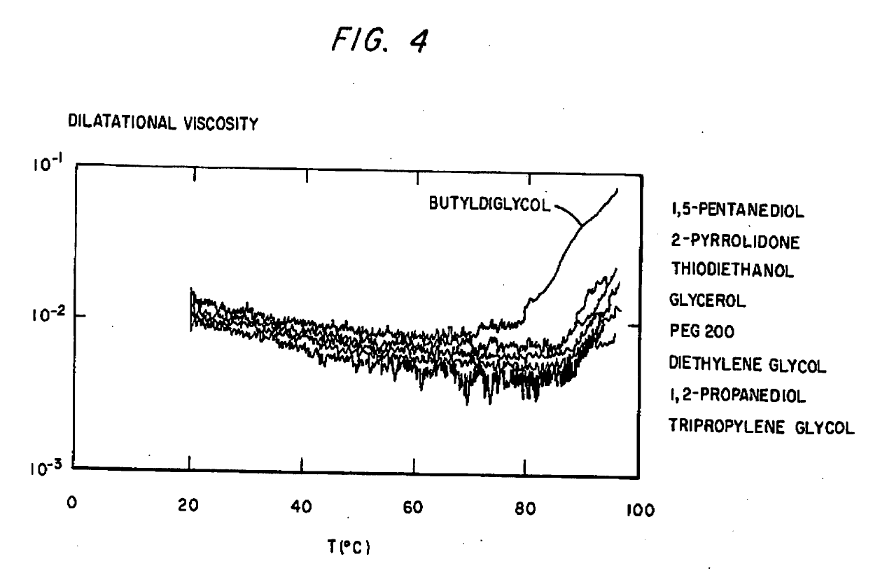

FIG. 4 illustrates the flocculation behaviour of a carbon black dispersion comprising a dispersant obtained by reaction of succinic anhydride and an ethoxylated polyethyleneimine of type B2 from DE-A 10026466. The carbon black is a Degussa Spezialschwarz type 4. This dispersion is likewise stable up to 80° C. to all solvents used.

### EXAMPLES

IR spectra were recorded on a 1613 Perkin Elmer instrument. The sample was pressed with KBr to form a tablet. The spectrum shows at 1730 cm⁻¹ the C═O stretch of the ester group and at about 1640 cm⁻¹ the C═O stretch of an amide.

Base fluid for printing tests of pigment-based inks:

15% of 1,5-pentanediol

10% of polyglycol 200

5% of 2-pyrrolidone

70% of completely ion-free water

### Example 1

### Preparation of a Sulphated Alkoxylated Polyethyleneimine

2000 g of an anhydrous ethoxylated-propoxylated polyethyleneimine (having 1.1% base nitrogen, a 63% polyoxyethylene content, a 1% polyoxypropylene content and an OH number of 72) are charged to a reaction vessel and melted. 278 g of sulphamic acid are added with stirring and the reaction mixture is stirred at 115° C. for 8 hours. Thereafter, the batch is diluted with 700 g of completely ion-free water and adjusted with ethanolamine to a pH of 7.5. This solution is diluted down to 30% and the sulphate content of 7% is then reduced to below 0.8% by means of membrane separation processes. The process parameters for the desalting are known from EP-A 816 406.

### Example 2

### Reaction of an Alkoxylated Polyethyleneimine with Succinic Anhydride

2000 g of an anhydrous ethoxylated-propoxylated polyethyleneimine (having 1.1% base nitrogen, a 63% polyoxyethylene content, a 1% polyoxypropylene content and an OH number of 72, average molar mass=2200 g/mol) are charged to a reaction vessel and melted. 140 g of succinic anhydride and 20 g of p-toluenesulphonic acid are added and the reaction mixture is stirred at 110° C. for 5 hours. The acid number of the reaction mixture was found to be 35. IR bands at 1730 and 1650 cm⁻¹. The reaction mixture is admixed with 630 g of completely ion-free water and adjusted to pH 8 with ethanolamine.

### Example 3

### Reaction of an Alkoxylated Polyethyleneimine with Succinic Anhydride

2000 g of an anhydrous ethoxylated-propoxylated polyethyleneimine (having 1.1% base nitrogen, a 63% polyoxyethylene content, a 1% polyoxypropylene content and an OH number of 72, average molar mass=2200 g/mol) are charged to a reaction vessel and melted. 280 g of succinic anhydride and 20 g of p-toluenesulphonic acid are added and the reaction mixture is stirred at 110° C. for 5 hours. The acid number of the reaction mixture was found to be 46. IR bands at 1730 and 1637 cm⁻¹. The reaction mixture is admixed with 630 g of completely ion-free water and adjusted to pH 8 with 150 g of ethanolamine.

### Example 4

### Reaction of an Alkoxylated Polyethyleneimine with Succinic Anhydride

1000 g of an anhydrous ethoxylated-propoxylated polyethyleneimine (having 3% base nitrogen, a 55% polyoxyethylene content, a 3% polyoxypropylene content and an OH number of 172, average molar mass=850 g/mol) are charged to a reaction vessel and melted. 380 g of succinic anhydride and 10 g of p-toluenesulphonic acid are added and the reaction mixture is stirred at 115° C. for 5 hours. The acid number of the reaction mixture was found to be 177. IR bands at 1730, 1639 and 1574 cm⁻¹. The reaction mixture is admixed with 400 g of completely ion-free water and adjusted to pH 8 with ethanolamine.

### Example 5

### Reaction of an Alkoxylated Polyethyleneimine with Phthalic Anhydride

1000 g of an anhydrous ethoxylated-propoxylated polyethyleneimine (having 3% base nitrogen, a 55% polyoxyethylene content, a 3% polyoxypropylene content and an OH number of 172, average molar mass=850 g/mol) are charged to a reaction vessel and melted. 500 g of phthalic anhydride and 10 g of p-toluenesulphonic acid are added and the reaction mixture is stirred at 120° C. for 5 hours. The acid number of the reaction mixture was found to be 141. IR bands at 1723 and 1640 cm⁻¹. The reaction mixture is admixed with 500 g of completely ion-free water and adjusted to pH 8 with ethanolamine.

### Example 6

### Reaction of an Alkoxylated Polyethyleneimine with Phenyl Isocyanate and Subsequent Functionalization with Succinic Anhydride

2000 g of an anhydrous ethoxylated-propoxylated polyethyleneimine (having 1.1% base nitrogen, a 63% polyoxyethylene content, a 1% polyoxypropylene content and an OH number of 72, average molar mass=2200 g/mol) are charged to a reaction vessel and melted. 85.2 g of phenyl isocyanate are added at 60° C. over 10 minutes with stirring and are stirred in for 1 hour. 140 g of succinic anhydride and 1 g of p-toluenesulphonic acid are then added and the reaction mixture is stirred at 110° C. for 2 hours. The acid number of the reaction mixture was found to be 34. The reaction mixture is admixed with 630 g of completely ion-free water and adjusted to pH 8 with 150 g of ethanolamine.

### Example 7

### Reaction of an Alkoxylated Polyethyleneimine with Stearyl Isocyanate and Subsequent Functionalization with Succinic Anhydride

2000 g of an anhydrous ethoxylated-propoxylated polyethyleneimine (having 1.1% base nitrogen, a 63% polyoxyethylene content, a 1% polyoxypropylene content and an OH number of 72, average molar mass=2200 g/mol) are charged to a reaction vessel and melted. 160 g of stearyl isocyanate are added at 60° C. over 10 minutes with stirring and are stirred in for 1 hour. 140 g of succinic anhydride and 1 g of p-toluenesulphonic acid are then added and the reaction mixture is stirred at 110° C. for 2 hours. The acid number of the reaction mixture was found to be 31. The reaction mixture is admixed with 630 g of completely ion-free water and adjusted to pH 8 with 150 g of ethanolamine.

### Example 8

### Pigment Preparation

100 g of a 30% solution of the dispersant of Example 1 (30 g solids) and 310 g of completely ion-free water are introduced as an initial charge. 90 g of an acidic carbon black having a BET surface area of 180 m²/g and a pH of <4.5 for a 5% aqueous slurry (Spezialschwarz®4 Degussa) were stirred in using a dissolver until the entire carbon black was wetted. The pH was adjusted to about 7.5 with ethanolamine.

The suspension was then introduced into an open 1 1 stirred media mill (from Sussmeier, Brussels) and ground using 1.1-1.4 mm zirconium oxide beads for 1 hour with cooling. The pH was readjusted if necessary during grinding. This pigment preparation was finished to form a printing ink:

6.94 g of pigment preparation and 18.06 g of base fluid were mixed, filtered through 5 μm and printed with an HP 6122 printer onto HP normal and premium paper.

The Y values measured in the Cielab system were 2.6 on normal paper and 1.9 on premium paper. Restarting printing after 24 h did not present any problems.

Y is a lightness parameter in the Cielab system and thus a measure of the colour strength of carbon blacks. The smaller the value, the blacker (i.e. stronger) the carbon black on the substrate (paper in this instance).

The fundamentals of colour measurement may be found in:

Farbmessung BAYER Farben Revue, Sonderheft 3/2D (1986)

### Example 9

### Pigment Preparation

200 g of a dispersant according to Example 3 were dissolved in 3000 g of completely ion-free water. Then 800 g of Spezialschwarz 4 (Degussa) were stirred in using a dissolver and the pH was adjusted to 7.5 with ethanolamine. The dispersion was then ground in an Advantis V-15 recirculation bead mill using 0.6 to 0.8 mm zirconium silicate beads for 35 minutes with cooling. The pH was readjusted as necessary during grinding. The carbon black dispersion after grinding was filtered through a filter having a 10 μm pore size. 5 g of pigment preparation and 20 g of base fluid were mixed, filtered through 5 μm and printed on an HP 6122 printer onto normal and premium paper. The Y values measured in the Cielab system were 2.5 on normal paper and 1.9 on premium paper. Printing restart after 24 h was possible without problems.

### Example 10

### Pigment Preparation

32 g of a dispersant from Example 4 were dissolved in 266.8 g of completely ion-free water. 100 g of Pigment Red 122 were then stirred in using a dissolver and the pH was adjusted to 7.5 with triethanolamine. The suspension was then introduced into an open 1 1 stirred media mill (from Sussmeier, Brussels) and ground using 0.6-0.8 mm zirconium oxide beads for 2 hours with cooling. The pH was readjusted as necessary during grinding.

This pigment preparation was finished to form a printing ink: 2 g of the pigment preparation were mixed with 23 g of the base fluid, filtered through 5 μm and printed onto normal and premium paper using an HP 6122 printer. The brilliant print was streak free and a restart of printing was readily possible.

| | | | | |
|---|---|---|---|---|
| The normal paper colour | L = 53 | a = 52 | b = −17 | C = 54.4 |
| locus was: | | | | |
| The premium paper colour | L = 44,5 | a = 62.3 | b = −10 | C = 63.1 |
| locus was: | | | | |

### Example 11

### Pigment Preparation

274 g of a dispersant according to Example 5 (200 g solids) were dissolved in 3000 g of completely ion-free water. Then 800 g of Spezialschwarz 6 (Degussa) were stirred in using a dissolver and the pH was adjusted to 7.5 with ethanolamine. The dispersion was then ground in an Advantis V-15 recirculation bead mill using 1.1 to 1.3 mm zirconium silicate beads for 35 minutes with cooling. The pH was readjusted as necessary during grinding. The carbon black dispersion after grinding was filtered through a filter having a 10 μm pore size.

5 g of pigment preparation and 20 g of base fluid were mixed, filtered through 5 μm and printed on an HP 6122 printer onto normal and premium paper.

The Y values measured in the Cielab system were 2.8 on normal paper and 2.2 on premium paper. Printing restart after 24 h was possible without problems.

5 g of pigment preparation were mixed with 20 g of a solution consisting of 20% of glycerol, 10% of butyldiglycol, 5% of diethylene glycol and 65% of completely ion-free water, filtered through 5 μm and printed onto normal and premium paper on an HP 6122 printer.

The Y values measured in the Cielab system were 3 on normal paper and 2.3 on premium paper.

(cf. in contrast values of a Comparative Test 2)

Similar values were incidentally obtained when butyltriglycol was used instead of butyldiglycol.

A restart of printing was readily possible after 24 h.

### Example 12

### Pigment Preparation

402.8 g of completely ion-free water, 56.8 g of a 70.4% solution of a dispersant from Example 4 and 340.40 g of a water-moist press cake of Pigment Yellow 150 are slurried up and homogenized using a dissolver. The pH is adjusted to 8 with ethanolamine. The dispersion is ground with 400 ml of zirconium silicate beads (1.1-1.3 mm in diameter) in a laboratory bead mill for 1 hour. 1.875 g of this ground dispersion and 23.125 g of base fluid are mixed, filtered through 5 μm and printed onto normal and premium paper on an HP 6122 printer. The prints were streak free and a printing restart after 24 h was possible without problems.

### Example 13

32 g of a dispersant from Example 2 were dissolved in 286.8 g of completely ion-free water. 80 g of Chromophtal DPP (flame red FP=Pigment Red 254) were then stirred in using a dissolver and the pH was adjusted from 5.2 to 8 with ethanolamine. The suspension was then introduced into an open 1 1 stirred media mill (from Sussmeier, Brussels) and ground using 1.1-1.25 mm zirconium oxide beads for 2 hours with cooling. The pH was readjusted as necessary during grinding.

This pigment preparation was finished to form a printing ink: 3.75 g of the pigment preparation were mixed with 21.25 g of the base fluid, filtered through 5 μm without problems and printed onto normal and premium paper using an HP 6122 printer.

The brilliant print was streak free and a restart of printing was readily possible.

| | | | |
|---|---|---|---|
| The normal paper colour locus was: | L = 60 | a = 54.3 | b = 25.92 |
| The premium paper colour locus was: | L = 57.1 | a = 57.8 | b = 30.9 |

### Comparative Example 1

### Alkoxylated Polyethyleneimine Only

416.9 g of an ethoxylated-propoxylated polyethyleneimine (with 1.1% base nitrogen, 63% polyoxyethylene, 1% polyoxypropylene) were dissolved in 2871 g of completely ion-free water. 1100 g of an acidic carbon black having a BET surface area of 180 m²/g (pH of a 5% slurry is <4.5) were then stirred in using a dissolver and the pH was adjusted to 7.5 with ethanolamine. The dispersion was then ground in an Advantis V 15 recirculation bead mill using 0.6-0.8 mm zirconium silicate beads for 60 minutes. The pH was readjusted as necessary during grinding. 5 g of pigment preparation and 20 g of base fluid were mixed, filtered through 5 μm and printed onto normal and premium paper using an HP 6122 printer. The Y values measured in the Cielab system were 9.5 on normal paper and 3 on premium paper. A printing restart after 24 h was possible without problems.

### Comparative Example 2

60 g of an ethoxylated-propoxylated polyethyleneimine (with 1.1% base nitrogen, 63% polyoxyethylene, 1% polyoxypropylene) and 240 g of a salt-free naphthalenesulphonic acid-formaldehyde condensate were dissolved in 3800 g of completely ion-free water. 900 g of an acidic carbon black having a BET surface area of 180 m²/g (pH of a 5% slurry is <4.5) were then stirred in using a dissolver and the pH was adjusted to 7.5 with ethanolamine (see FIG. 2). The dispersion was then ground in an Advantis V 15 recirculation bead mill using 0.6-0.8 mm zirconium silicate beads for 60 minutes. The pH was readjusted as necessary during grinding. 5 g of pigment preparation and 20 g of base fluid were mixed, filtered through 5 μm and printed onto normal and premium paper using an HP 6122 printer. The Y values measured in the Cielab system were 3.5 on normal paper and 2.7 on premium paper. A printing restart after 24 h was possible without problems. 5 g of pigment preparation were mixed with 20 g of a solution consisting of 20% of glycerol, 10% of butyldiglycol, 5% of diethylene glycol and 65% of completely ion-free water, filtered through 5 μm and printed onto normal and premium paper using an HP 6122 printer. The Y values measured in the Cielab system were 4.3 on normal paper and 3.3 on premium paper. A restart of printing was readily possible after 24 h.

1. Polyalkylenepolyimines having alkoxy units and anionic groups, especially those from the group consisting of —COO^{σ}, —SO₃^{σ}, —OSO₃^{σ}, —POₑ²⁻ and —P(OR)O₂^{σ}, where R represents hydrogen or optionally substituted alkyl, cycloalkyl or aryl.

2. Polyalkylenepolyimines according to claim 1, characterized in that they are branched polyethylenepolyimines.

3. Polyalkylenepolyimines according to either or both of claims 1 and 2, characterized in that they contain amide groups and/or urethane groups and/or urea groups.

4. Polyalkylenepolyimines according to at least one of claims 1 to 3, characterized in that they contain ethoxy and propoxy and/or butoxy units.

5. Polyalkylenepolyimines according to at least one of claims 1 to 4, characterized in that they comprise 1-10 mol of propylene oxide or butylene oxide units and 10-40 mol of ethylene oxide units per NH function.

6. Polyalkyleneimines according to at least one of claims 1 to 5, characterized in that they contain a —COO anionic group.

7. Polyalkylenepolyimines according to at least one of claims 1 to 6, characterized in that they have an average molecular weight from 800 to 30 000 g/mol.

8. Process for preparing polyalkylenepolyimines according to at least one of claims 1 to 7, characterized in that an alkoxylated polyalkylenepolyimine is reacted with an agent for introducing anionic groups, especially with di- to polycarboxylic acids or derivatives thereof, sulphonating, sulphating or phosphating agents.

9. Polyalkylenepolyimines obtainable by the process of claim 8.

10. Pigment preparations comprising
A) at least one pigment,
B) at least one alkoxylated polyalkyleneimine according to at least one of claims 1 to 7 or 9.

11. Pigment preparation as defined in claim 10, comprising a pigment which has a pH<6 on. being slurried up in water in a 5% by weight concentration.

12. Pigment preparation as defined in either or both of claims 10 and 11, comprising said component B) in an amount from 1% to 200% by weight, based on the pigment of said component A).

13. Pigment preparation as defined in at least one of claims 10 to 12, comprising an aqueous medium C), preferably in an amount from 1% to 98% by weight, based on the preparation.

14. Pigment preparations as defined in at least one of claims 10 to 13, characterized in that the aqueous medium C) comprises water C1) and at least one organic solvent C2), especially butyldiglycol and/or butyltriglycol.

15. Process for preparing pigment preparations as defined in at least one of claims 10 to 14, characterized in that said components A) and B) are homogenized in the presence of water C1) and if appropriate C2), if appropriate freed of coarse particles, preferably by means of membranes or glass filters, and if appropriate the pigment preparation is dried.

16. Use of the Process for printing sheetlike or three-dimensionally configured substrates especially paper by means of ink jet processes characterized in that a pigment preparation of at least one of claims 10 to 14 is used.
